(19) United States
(12) Patent Application Publication
(10) Pub. No.: US 2016/0018089 A1
(43) Pub. Date: Jan. 21, 2016

(54) LAMP HAVING MULTIPLE MOUNTINGS

(71) Applicant: Grote Industries, Inc., Madison, IN (US)

(72) Inventor: Nikola Dragov, Madison, IN (US)

(21) Appl. No.: 14/336,227

(22) Filed: Jul. 21, 2014

(51) Int. Cl. F21V 21/00; F21V 15/01; F21K 99/00; F21V 29/74

(52) U.S. Cl. CPC F21V 21/00; F21V 29/74; F21V 15/01; F21K 9/50; F21Y 2101/02

(57) ABSTRACT

An electric lamp is disclosed with a housing, a light transmissive cover on a front of the housing which with the housing forms an interior space, and a light emitter in the interior space, wherein light from the emitter is transmissible through the cover in a forward direction. First, second and third mount receptacles adapted for receiving different mounts to hold the lamp are disclosed.

### BACKGROUND

The present invention relates to electric lamps and to mountings for them.

Lamps are free-standing (like a table lamp), hung (like a chandelier), or mounted. Mounted lamps typically have a fixture, or mounting receptacle, adapted to receive the mount. There are a variety of such mounts, including without limitation face mounts, central brackets, U-shaped and O-shaped frames surrounding the lamp housing, and otherwise. This variety adds complexity and cost, including added inventory costs of accommodating the variety of mounts. It would be desirable if a lamp had a mounting receptacle that worked so well and had such outstanding flexibility of application that industry/users would agree to standardize on such single mount receptacle design.

Thus, there is a need for improvement in this field.

### SUMMARY

The claims, and only the claims, recite the inventions. In general summary, the lamp may include a housing, a light transmissive cover on a front of the housing which with the housing forms an interior space, and at least one light emitter in the interior space, wherein light from the emitter is transmissible through the cover in a forward direction. The lamp also has a first mount receptacle adapted for receiving a first mount to hold the lamp; and, a second mount receptacle separate from the first mount receptacle, the second mount receptacle adapted for receiving a second mount which is shaped differently than the first mount, to hold the lamp. Third mount receptacles and other elements, as separately claimed, may or may not be included.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is an exploded top perspective view of one example of a lamp according to the claims, along with three examples of mounts.

FIG. 2 is a side view of the lamp of FIG. 1 (assembled) mounted on a mount.

FIG. 3 is a side view of the lamp of FIG. 1 (assembled) mounted on a different mount.

FIG. 4 is a side view of the lamp of FIG. 1 (assembled) mounted on a yet different mount.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

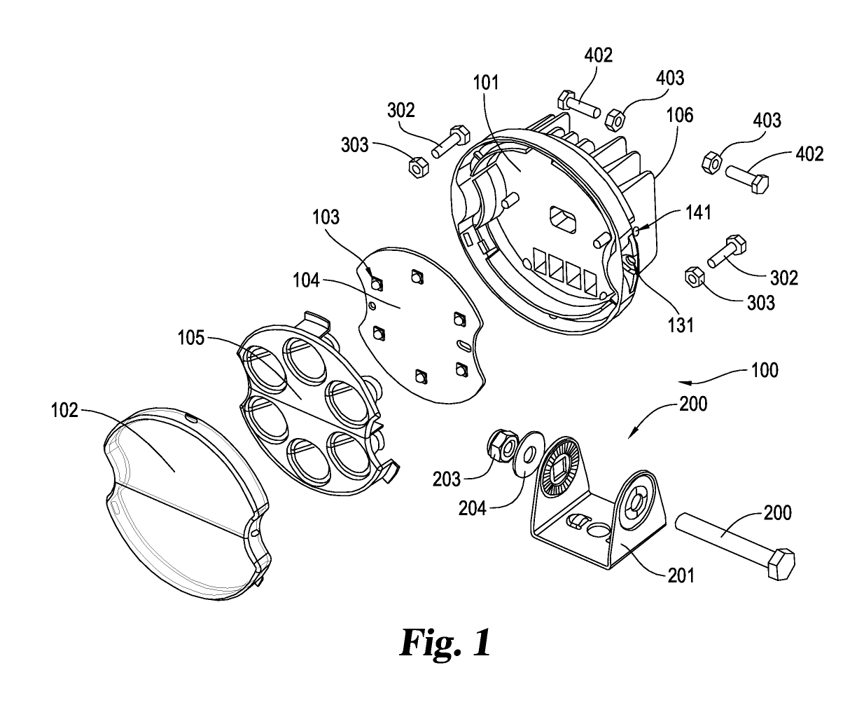

Referring to the examples shown in the drawings (FIGS. 1-4), an electric lamp 100 is shown comprising a housing 101, a light transmissive cover 102 on a front of the housing which with the housing 101 forms an interior space, and at least one light emitter 103 in the interior space, wherein light from the emitter is transmissible through the cover in a forward direction D (see FIGS. 2-4). The lamp also has a first mount receptacle 121, 131 or 141 adapted for receiving a first mount to hold the lamp; and, a second mount receptacle 121, 131 or 141, separate from the first mount receptacle, the second mount receptacle adapted for receiving a second mount which is shaped differently than the first mount, to hold the lamp. The example lamp 100 shown may be altered may ways, including its shape (round, rectangular, oval, square, hexagonal, octagonal, or otherwise), its configuration, the number and type and layout of light emitters, and otherwise.

Optionally, but not necessarily, the lamp may include a third mount receptacle 121, 131 or 141, separate from the first and second mount receptacles, the third mount receptacle adapted for receiving a third mount which is different than the first and second mounts, to hold the lamp.

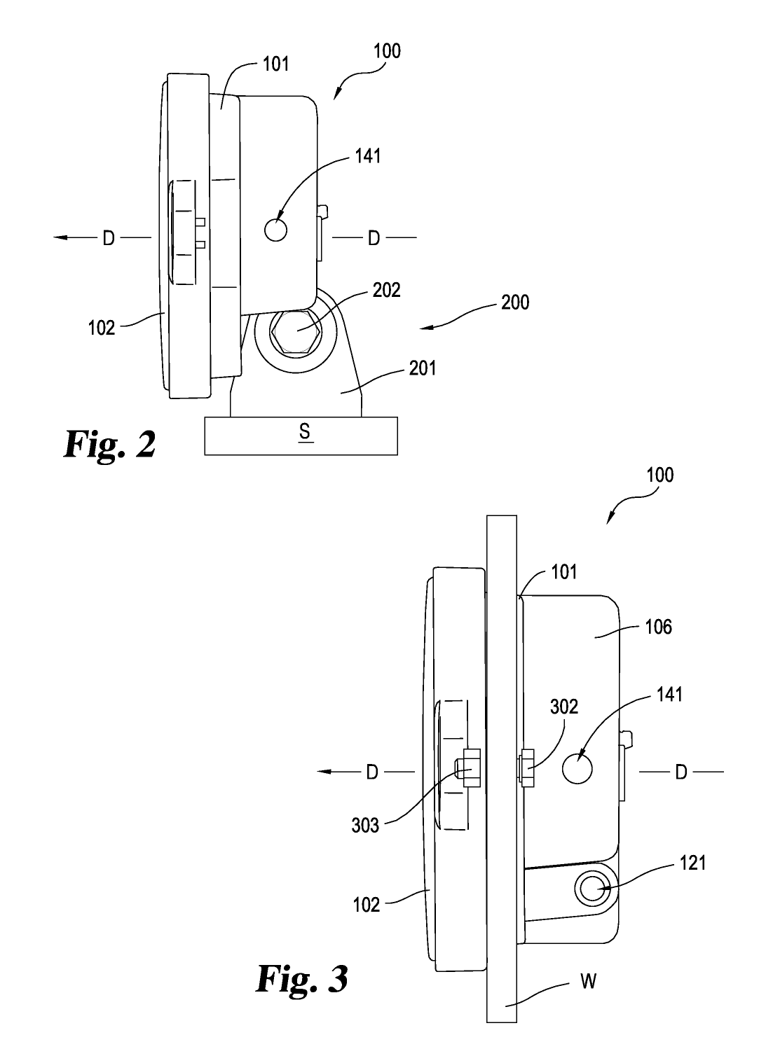

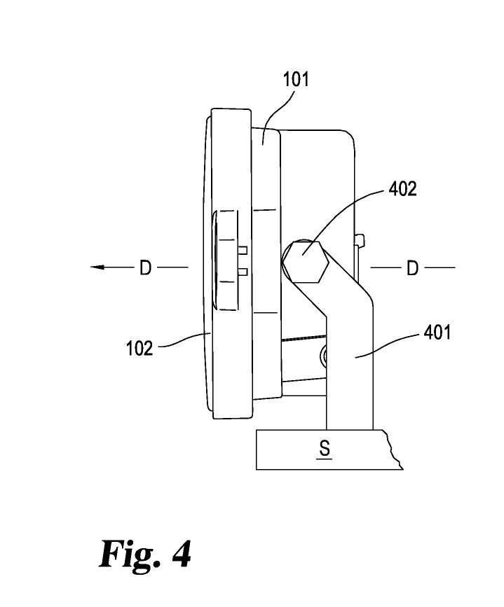

Optionally, but not necessarily, the first, second and/or third mount receptacle may be selected from a first group consisting of: (i) a pair of coaxial openings, such as opening 141 generally transverse to the forward direction D of the lamp on opposite sides the housing (only one of the two is depicted in the figures) and adapted to receive two respective fasteners 402 (with or without nuts 403, such as for example to mount to mount bracket 401 (FIG. 4)); (ii) an aperture 121 (see for example FIG. 3) generally transverse to the forward direction D of the lamp, the generally transverse aperture being through at least a portion of the housing and adapted to receive a shank 202 therethrough (with or without mount 200 and the illustrated bracket 201, nut 203, and washer 204); and, (iii) at least two holes 131 in the housing (only one of the two is depicted in the figures), the cover, or both, with the holes 131 being oriented generally parallel to the first direction of the lamp and adapted to receive two respective fasteners 302 (with or without nuts 303) for face-mounting the lamp, such as for example through or to wall W (FIG. 4). The second mount receptacle, and/or the third mount receptacle, which are different from each other and the first mount receptacle, may be otherwise selected from the first group. Such mount receptacles and their mounts may vary from these examples. The mount may itself be part of or mounted to structure S (FIGS. 2 and 4).

Optionally, but not necessarily, the housing 101 comprises a metal housing, and wherein the light emitter 103 comprises at least one LED. Optionally, but not necessarily, the lamp may include further comprising a plurality of heat dissipating fins, such as fin 106, on the outside of the housing. Note also that in the illustrated example, optionally, mount receptacle 121 is laterally inboard of receptacles 141 which are themselves laterally inboard of receptacles 131.

Optionally, but not necessarily, the lamp includes at least three white LEDs and wherein the lamp is a work lamp emitting less than 1,000 effective lumens. However, more LEDs and/or more lumens may be used as well. Optionally, but not necessarily, the lamp includes one or more circuit board 104 and/or light reflector 105.

Optionally, but not necessarily, the lamp passes the requirements of JCB Standard 140. And, optionally, but not necessarily, the lamp passes the requirements of JDQ53.3.

Optionally, but not necessarily, the lamp's housing, cover and light emitter are, apart from mounting, assembled without screws (see for example parts for lamp 100 in FIG. 1). Optionally, but not necessarily, the lamp's housing and cover form (alone or with other components) an interior space which is sealed from outside moisture.

Optionally, but not necessarily, the lamp may be part of a kit (for one example, FIG. 1) also including first mount means 202 for mounting the lamp, second mount means 302 for mounting the lamp, and third mount means 402 for mounting the lamp.

As used here (claims, specification, and other definitions) the following terms have the following meaning:

Articles and phases such as, “the”, “a”, “an”, “at least one”, and “a first”, “comprising”, “having” and “including” here are not limited to mean only one, but rather are inclusive and open ended to also include, optionally, two or more of such elements and/or other elements. In terms of the meaning of words or terms or phrases herein, literal differences therein are not superfluous and have different meaning, and are not to be synonymous with words or terms or phrases in the same or other claims.

The term “and/or” is inclusive here, meaning “and” as well as “or”. For example, “P and/or 0” encompasses, P, Q, and P with Q; and, such “P and/or 0” may include other elements as well.

The term “LED” as used herein means light emitting diode, including single diodes as well as arrays of LED's and/or grouped light emitting diodes. This can include the die and/or and LED film or other laminate, LED packages, the packages may include encapsulating material around a die, and the material, typically transparent, may or may not have color tinting and/or may or may not have a colored sub-cover. An LED can be a variety of colors, shapes, sizes and designs, including with or without heat sinking, lenses, or reflectors, built into a package.

The term “elongated aperture” as used herein means one or more holes, openings or tube aligned such that an axial body, such as a bolt shank, other shank or the like may pass through it and/or them, and collectively the length is greater than the smallest diameter.

The term “generally transverse” as used herein means perpendicular, normal or skew, each at 90 degrees plus or minus 15 degrees.

The term “light” as used herein means light which is visible to the naked human eye.

The term “mount receptacle” as used herein has the meaning, of structure to mechanically receive part or all of a mount. Such structure may include, for example, holes (threaded and/or unthreaded), apertures, brackets, posts (threaded and/or unthreaded), bayonets, and detents.

The term “mount” as used herein has the meaning, one or more mechanical parts to mechanically mount a lamp to a separate wall or other structure (of a building, vehicle, machine, or otherwise). It may be movable (pivot and/or pan) and/or fixed.

The term “emitter” as used herein has the meaning, of and LED or light bulb.

The language used in the claims and the written description and in the above definitions is to only have its plain and ordinary meaning, except for terms explicitly defined above. Such plain and ordinary meaning is defined here as inclusive of all consistent dictionary definitions from the most recently published (on the filing date of this document) general purpose Webster's dictionaries and Random House dictionaries.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. An electric lamp, comprising:
a housing;
a light transmissive cover on a front of the housing which with the housing defines an interior space;
at least one light emitter in the interior space, wherein light from the emitter is transmissible through the cover in a forward direction;
a first mount receptacle defining a pair of coaxial openings on opposite sides of said housing adapted for receiving a first mount to hold said lamp,
a second mount receptacle defining an elongated aperture generally transverse to said forward direction of the lamp, said generally transverse aperture being through at least a portion of said housing and adapted to receive a shank therethrough, wherein said second mount receptacle is separate from said first mount receptacle, said second mount receptacle is adapted for receiving a second mount;
a third mount receptacle defining at least two holes in said housing, said cover, or both, said holes being oriented generally parallel to said forward direction of said lamp and adapted to receive two respective fasteners for face-mounting said lamp, separate from said first and second mount receptacles, said third mount receptacle adapted for receiving a third mount; and
wherein said first, second, and third mount receptacles are configured and arranged to receive mounts with different shapes.

2. (canceled)

3. (canceled)

4. (canceled)

5. The lamp of claim 1, wherein said housing comprises a metal housing, and wherein said light emitter comprises at least one LED.

6. The lamp of claim 5, and further comprising a plurality of heat dissipating fins on the outside of said housing.

7. The lamp of claim 6, wherein said lamp includes at least three white LEDs and wherein the lamp is a work lamp emitting less than 1,000 effective lumens.

8. The lamp of claim 7, wherein the lamp's housing, cover and light emitter are, apart from mounting, assembled without screws.

9. (canceled)

10. (canceled)

11. The lamp of claim 1, and further comprising a plurality of heat dissipating fins on the outside of said housing.

12. The lamp of claim 1, wherein said lamp includes at least three white LEDs and wherein the lamp is a Work lamp emitting less than 1,000 effective lumens.

13. The lamp of claim 1, wherein the lamp's housing, cover and light emitter are apart from mounting, assembled without screws.

14. The lamp of claim 1 as part of a kit also including first mount means for mounting the lamp, second mount means for mounting the lamp, and third mount means for mounting the lamp.

15. (canceled)

16. (canceled)

17. The lamp of claim 11, wherein one or more of said plurality of heat dissipating fins define said pair of coaxial threaded members of said first mounting receptacle.

18. An electric lamp, comprising:
a housing;
at least one light emitter coupled to said housing;
a first mount receptacle defined by said housing configured and arranged for receiving a first mount to hold the lamp, wherein said first mount receptacle defines a plurality of openings that are substantially coaxial;
a second mount receptacle defined by said housing configured and arranged for receiving a second mount, wherein said second mount receptacle defines a plurality of openings that are substantially coaxial and oriented parallel to said plurality of openings of said first mount; and
a third mount receptacle defined by said housing configured and arranged for receiving a third mount, wherein said third mount receptacle defines a plurality of openings, wherein at least one of said plurality of openings is oriented transverse to said openings of said first mount.

19. The lamp of claim 18, wherein said openings of said first mount receptacle are located on opposite sides of said housing.

20. The lamp of claim 19, wherein said openings of said first mount receptacle extend through the housing such that a single shank can be inserted through said openings.

21. The lamp of claim 18, wherein said plurality of openings of said third mount receptacle are all oriented transverse to said openings of said first mount.

22. The lamp of claim 18, wherein said openings of said third mount receptacle are oriented generally parallel to the forward direction of said lamp.
